(19) United States
(12) Patent Application Publication
(10) Pub. No.: US 2005/0062755 A1
(43) Pub. Date: Mar. 24, 2005

(54) YUV display buffer

(76) Inventors: Phil Van Dyke, Surrey (CA); Raymond Chow, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/666,438

(22) Filed: Sep. 18, 2003

(51) Int. Cl. G09G 5/02; G09G 5/00; G09G 5/397; G09G 5/36; G06T 9/00

(52) U.S. Cl. 345/603; 345/600; 345/3.2; 345/546; 345/547; 345/555

(57) ABSTRACT

A method for enhancing storage capability for a display controller initiates with receiving video display data having a color format associated with a first sub-sampling scheme. Then, a size associated with the video display data is adjusted. Next, the video display data is compressed through a second sub-sampling scheme. Then, the compressed data having the color format is stored. A computer readable medium, a display controller and a digital video device are also provided as environments in which the method can be stored and/or implemented.

### CROSS REFERENCE TO RELATED APPLICATIONS

This application is related to U.S. patent application Ser. No. ______ (Attorney Docket No. VP088), filed on the same day as the instant application and entitled “METHOD AND APPARATUS FOR COLOR SPACE CONVERSION.” This application is hereby incorporated by reference in its entirety for all purposes.

### BACKGROUND OF THE INVENTION

1. Field of the Invention

This invention relates generally to computer systems and more particularly to a method and apparatus for more efficiently storing image data to be displayed.

2. Description of the Related Art

Current liquid crystal display (LCD) controller designs incorporate display buffers that only support display data in RGB format. As is generally known, RGB format display data varies in color depth from 8, 16, or 24 bit-per-pixel (bpp). Newer LCD controllers incorporating digital video features, such as video input ports, JPEG, and MPEG functionality, require 16 or 24 bpp color depths to properly display live video or still images. Typically, the display data coming from various modules are converted to RGB format before storage into the display buffer. The support for higher color depths and increased display sizes, strains the memory allocation for the display buffer (internal RAM) because a large portion of the resulting manufacturing cost of an LCD controller is determined by the allocation of silicon for embedded RAM.

For current generations of LCD controllers that support a camera interface and a JPEG CODEC, incoming YUV data from these modules are first converted to 16 bpp or 24 bpp (unpacked 32-bits wide) RGB data format by a YUV-RGB Converter (YRC). The converted data is then stored in the display buffer. However, this process decompresses the display data resulting in a larger RAM requirement for storage in the display buffer. For example, YUV 4:2:2 pixel data coming from the camera interface is 16-bits wide and equivalent to 24 bpp. A resultant YUV-RGB conversion to 24 bpp unpacked (32-bits wide) would increase the memory storage requirement by 2 times. A resultant YUV-RGB conversion to 16 bpp would not increase the memory storage requirement but the resulting image fidelity is decreased (color depth from 24 bpp to 16 bpp).

FIG. 1 is a high-level, simplified schematic diagram of the architecture for a device having a liquid crystal display controller configured to solely support display data in RGB format. The components include central processing unit (CPU) 100 in communication with display controller 102. Display controller 102 is in communication with display panel 104. Display controller 102 is configured to convert any incoming YUV formatted data to RGB format prior to storing the data within a memory of the display controller.

As a result, there is a need to solve the problems of the prior art to provide a display controller configured to support storage of the YUV color format in order to minimize the memory capacity necessary for the storage of the display data.

### SUMMARY OF THE INVENTION

Broadly speaking, the present invention fills these needs by providing a display buffer that supports display data in various YUV formats. It should be appreciated that the present invention can be implemented in numerous ways, including as a process, a system, or a device. Several inventive embodiments of the present invention are described below.

In one embodiment, a method for enhancing storage capability for a display controller is provided. The method initiates with receiving video display data having a color format associated with a first sub-sampling scheme. Then, a size associated with the video display data is adjusted. Next, the video display data is compressed through a second sub-sampling scheme. Then, the compressed data having the color format is stored.

In another embodiment, a computer readable medium having program instructions for enhancing storage capability for a display controller is provided. The computer readable medium includes program instructions for receiving video display data having a color format associated with a first sub-sampling scheme. Program instructions for adjusting a size associated with the video display data are included. Program instructions for compressing the video display data through a second sub-sampling scheme are provided. Program instructions for storing the compressed data having the color format are also included.

In yet another embodiment, a display controller is provided. The display controller includes a resizer block configured to receive digital video data defined through a YUV color format. The resizer block is capable of scaling and cropping the digital video data. A conversion module configured to compress the digital video data defined through the YUV color format is included. A memory region configured to store the compressed digital video data and a color space conversion block configured to convert the compressed digital video data from the YUV color format to an RGB color format for display are included in the display controller.

In still yet another embodiment, a digital video device is provided. The digital video device includes a central processing unit (CPU). A display controller is also included. The display controller includes a resizer block configured to receive digital video data defined through a YUV color format. The resizer block is capable of scaling and cropping the digital video data. A conversion module configured to compress the digital video data defined through the YUV color format is included in the display controller. A memory region configured to store the compressed digital video data is provided in the display controller. The digital video device includes a display panel configured to display the stored digital video data. A bus over which the CPU, the display controller and the display panel communicate is also provided.

In another embodiment, an integrated circuit is provided. The integrated circuit includes circuitry for receiving previously compressed digital video data. Circuitry for sub-sampling the previously compressed digital video data is provided. Circuitry for storing the sub-sampled data is also included.

Other aspects and advantages of the invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, and like reference numerals designate like structural elements.

FIG. 1 is a high-level, simplified-schematic diagram of the architecture for a device having a liquid crystal display controller configured to solely support display data in RGB format.

FIG. 2 is a high level schematic diagram of the system architecture for a device configured to efficiently utilize a compression state of incoming color data in accordance with one embodiment of the invention.

FIG. 3 is a more detailed schematic diagram of the components of a display controller configured to further compress digital video input received in a compressed format in accordance with one embodiment of the invention.

FIG. 4 is an alternative embodiment of FIG. 3 which includes color space conversion modules in order to achieve backward compatibility for RGB color formatted data in accordance with one embodiment of the invention.

FIG. 5 is a flow chart diagram illustrating the method operations for enhancing storage capability for display controller in accordance with one embodiment of the invention.

### DETAILED DESCRIPTION OF THE PREFERRED EMBODIMENTS

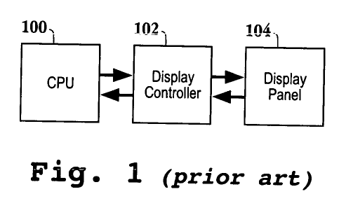

An invention is described for an apparatus and method for exploiting the compression options associated with YUV color formatted data, or data derived from YUV color data, in order to conserve memory space. It will be apparent, however, to one skilled in the art, in light of the present disclosure, that the present invention may be practiced without some or all of these specific details. In other instances, well known process operations have not been described in detail in order not to unnecessarily obscure the present invention. FIG. 1 is described in the “Background of the Invention” section.

The embodiments of the present invention provide a display controller having a display buffer that natively supports various YUV formats. One skilled in the art will appreciate that the various YUV formats include Y′CbCr, YIQ, etc. The embodiments described herein avoid converting the YUV format to a RGB format and subsequently storing the data in memory as RGB formatted data. Consequently, the YUV display buffer may hold more display data relative to a display buffer holding RGB formatted data. Furthermore, higher color depths and larger display sizes may be supported with smaller display buffer sizes. As will be explained in more detail below, the increased storage capability is accomplished by compressing the YUV data through various schemes of sub-sampling chrominance pixel data, e.g., UV pixel data and CbCr pixel data. The sub-sampling results in negligible loss of image fidelity as the human eye is more sensitive to the luminance detail than the color detail.

In one embodiment, the display controller is capable of supporting any of the following four YUV formats:
1. 4:4:4:—Full sampling. Each pixel sample has an 8-bit Y, U and V component.
2. 4:2:2—Sub-sampling. Each pixel sample has an 8-bit Y component while the U and V component is sampled horizontally every second pixel.
3. 4:1:1—Sub-sampling. Each pixel sample has an 8-bit Y component while the U and V component is sampled horizontally every fourth pixel.
4. 4:2:0—Sub-sampling. Each pixel sample has an 8-bit Y component while the U and V component is sampled horizontally and vertically every second pixel.

It should be appreciated that each of the above four formats is equivalent to an RGB color depth of 24 bits per pixel (bpp), thereby allowing varying levels of lossy compression. Table 1 illustrates the memory requirements for each YUV format and compression achieved as compared to RGB data at 24 bpp.

TABLE 1

| YUV Format | Memory/Pixel | Compression (compared to RGB) |
|---|---|---|
| 4:4:4 | 24 bits | 1:1 |
| | | (24 Bpp packed) |
| | | 1.3:1 |
| | | (24 Bpp unpacked, 32 bits) |
| 4:2:2 | 16 bits | 1.5:1 |
| 4:1:1 | 12 bits | 2:1 |
| 4:2:0 | 12 bits | |

As can be seen the compression ratios can range anywhere from 1.3:1 to 2:1. Thus a significant savings in terms of memory may be realized through the embodiments described herein. As most digital video devices transmit YUV data associated with a 4:2:2 compression format, it should be appreciated that in this situation, the 4:2:2 compression format is downsampled to yield a 4:1:1 or 4:2:0 compression format. However, where 4:4:4 YUV data is received, the embodiments described herein also apply.

Table 2 illustrates the memory requirements for a 320×240 image in each of the compressed YUV formats. One skilled in the art will appreciate that the 320×240 image size is characteristic of a display screen for a personal digital assistant (PDA). However, it should be appreciated that the embodiments described herein are not limited to this size screen and may be applied to any suitable size screen.

TABLE 2

| | | | |
|---|---|---|---|
| 24 bpp unpacked RGB | 16 bpp RGB | YUV 4:2:2 | YUV 4:1:1 or |
| | | | 4:2:0 |
| 300K Bytes | 150K Bytes | 150K Bytes | 112.5K Bytes |

With reference to Table 2, YUV data storage would give a best case savings in memory requirements of 62.5% as compared against RGB 24 bpp unpacked data and a 25% savings against RGB 16 bpp. The worst case savings in memory requirements would be 25% against 24 bpp unpacked RGB and no savings against RGB 16 bpp, however, the YUV format offers higher color depth than the RGB format.

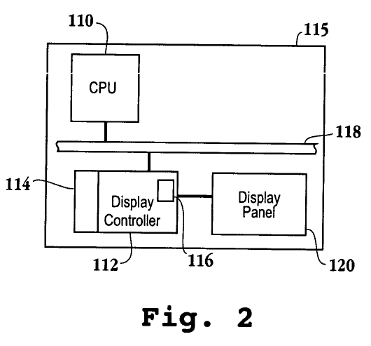

FIG. 2 is a high level schematic diagram of the system architecture for a device configured to efficiently utilize a compression state of incoming color data in accordance with one embodiment of the invention. Device 115 includes central processing unit (CPU) 110 display controller 112 and display panel 120. CPU 110 is in communication with display controller 112 through bus 118. Display panel 120 is in communication with display panel controller 112. Display controller 112 includes memory region 114 and sub-sampling module 116. As will be explained further below, sub-sampling module 116 is configured to sub-sample incoming color image data in order to minimize an amount of capacity used in memory 114 to store the incoming color image data. In one embodiment, the incoming color image data is in a YUV format that is received through a 4:2:2 compression scheme. Thus, sub-sampling module 116 may further increase the compression, i.e., convert the 4:2:2 compression scheme to either a 4:1:1 compression scheme or a 4:2:0 compression scheme.

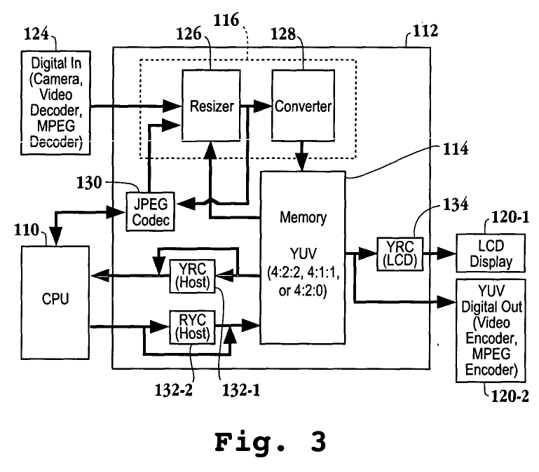

FIG. 3 is a more detailed schematic diagram of the components of a display controller configured to further compress digital video input received in a compressed format in accordance with one embodiment of the invention. Incoming digital data 124 is received by resizer module 126. It should be appreciated that the incoming digital data may originate from any video device, e.g., a digital camera, a video decoder, a Motion Picture Expert Group (MPEG) decoder, etc. Resizer module 126 is configured to adjust a size associated with the incoming digital data for eventual display on a display panel in communication with display controller 112. In one embodiment, resizer module 126 is configured to adjust a crop factor and a scale factor associated with the incoming digital data. That is, by adjusting the crop factor and the scale factor, the image is cropped and scaled, respectively, for output. In other words, the function of the resize and scaler block (resizer module 126) is to trim or scale image data coming from either the Digital Video Input port, or from display memory, i.e., JPEG encode from display memory. Resizer module 126 is associated with a YUV-YUV converter (converter 128) to select the appropriate YUV output format. The output of resizer module 126 and converter 128, which make up sub-sampling module 116, may be stored in display memory or sent to the JPEG CODEC.

Converter 128 is configured to sub-sample the image data in order to further compress the data to conserve space within memory 114. For example, the incoming digital data is typically of a YUV color format which has been compressed through a 4:2:2 compression scheme. Converter 128 will take the color data in the 4:2:2 compression scheme and sub-sample the data to convert the data to a YUV format having either a 4:1:1 compression ratio or a 4:2:0 compression ratio. The further compressed YUV data is then stored in memory 114. As illustrated in Tables 1 and 2, a significant savings may be achieved by storing the further compressed YUV data in memory 114 as opposed to 24 bpp RGB data.

Still referring to FIG. 3, from memory 114, the data may be transmitted through color space conversion module 134 where the YUV color format is converted to RGB color format in order to be displayed on liquid crystal display (LCD) display 120-1. Alternatively, the YUV data stored in memory 114 may be transmitted directly to a device or apparatus configured to accept YUV data. A video encoder or a Motion Picture Expert Group encoder are exemplary devices which can accept the YUV format. As central processing units generally operate on RGB data, CPU 110, when communicating with display controller 112, may utilize color space conversion modules 132-1 and 132-2 to convert the data between RGB format and YUV format. Thus, when writing to display controller 112, then RGB data is converted to YUV data through module 132-2. On the other hand, where the CPU is reading from memory 114 of display controller 112, the YUV data is converted to RGB data through module 132-1. That is, color space conversion (CSC) blocks 132-1 and 132-2 are placed between the CPU host interface and the display buffer to enable the host CPU to still read and write data to the memory in RGB format (or YUV directly by bypassing CSC blocks 132-1 and 132-2). A YUV-RGB Converter (YRC) is implemented in the read path and a RGB-YUV Converter (RYC) is implemented in the write path. It should be appreciated that the YRC output and RYC input is configurable to different bpp modes. In one embodiment, CPU host accesses to the internal register and JPEG CODEC are not converted and the data is read/written directly. The CPU host software should be aware that when display data is written to internal memory, the value read back may be different since the write data may have been downsampled by compression. However, in most display applications, the CPU host rarely requires read back verification of display data from the frame buffer.

Still referring to FIG. 3, Joint Photographic Expert Group (JPEG) codec 130 may encode the video data 124 coming into display controller 112 directly. Alternatively, JPEG codec 130 may encode the video display data that is stored in memory 114. Thus, when encoding digital video data 124, the digital data is transmitted to resizer 126 and is then transmitted from resizer 126 to JPEG codec 130. The data is then encoded through JPEG codec 130 and transmitted to CPU 110. When encoding data from memory, the stored data is accessed from memory 114 and transmitted to resizer 126, where subsequently the data is transmitted to JPEG codes 130. Accordingly, in the case of JPEG encode operation, the JPEG CODEC encodes data from either the Digital Video Input Port or from display memory. Since display data in the memory is typically YUV format, the JPEG CODEC can encode data directly from the display memory without a RYC conversion. In one embodiment, the JPEG CODEC may be bypassed to stream raw camera data directly to the CPU host. In the case of JPEG decode operation, the JPEG CODEC decodes data from the CPU host. The decoded data is sent through resizer block 126, and storage into display memory. The decoded image data is in YUV format, therefore, the data does not require YRC conversion prior to storage in the display buffer.

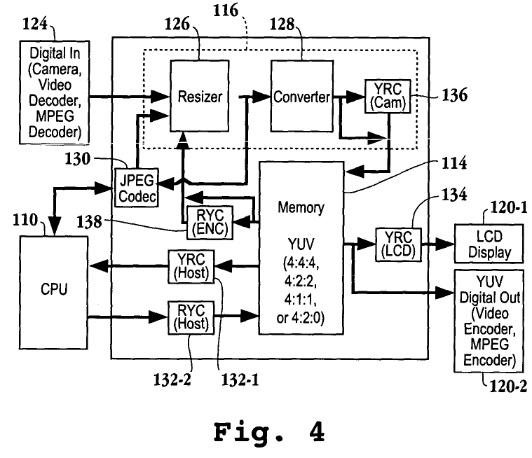

FIG. 4 is an alternative embodiment of FIG. 3 which includes color space conversion modules in order to achieve backward compatibility for RGB color formatted data in accordance with one embodiment of the invention. Here, color space conversion module 136 is included within sub-sampling module 116 along with resizer module 126 and converter 128. Thus, if desired, the YUV data may be stored into memory 114 as RGB color format. Additionally, color space conversion module 138 is also included in order to convert any RGB data stored in memory 114 to a YUV format for eventual delivery to resizer 126. Of course, each of these color space conversion modules 136 and 138 may be bypassed where the data is stored in memory 114 as YUV formatted data or a format deriver from the YUV data. The two optional CSC blocks, 136 and 138, may be included to enhance display controller 116 design. These two additional CSC blocks allows memory 114, also referred to as a display buffer, to be color space compatible with either conventional RGB format or compressible YUV format. Therefore, display data from the Digital Video Input port or CPU host interface may be in either of the RGB or YUV color space formats depending on whether the CSC blocks are enabled or bypassed. The color space conversion modules discussed herein may employ the color space conversion scheme discussed in application Ser. No. ______ (Attorney Docket No. VP088) in one embodiment of the invention.

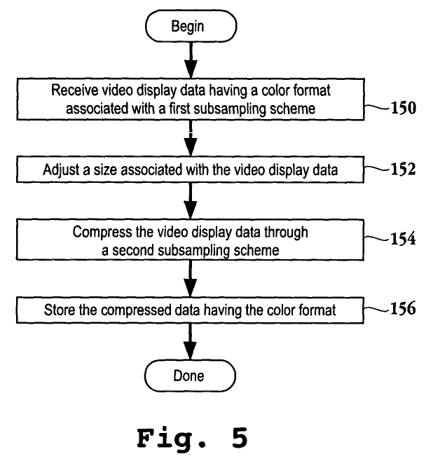

FIG. 5 is a flow chart diagram illustrating the method operations for enhancing storage capability for display controller in accordance with one embodiment of the invention. The method initiates with operation 150 where video display data having a color format associated with a first sub-sampling scheme is received. In one embodiment, the video display data is received from a digital video device, e.g., digital camera, video decoder, MPEG decoder. In another embodiment, the first sub-sampling scheme is a 4:2:2 compression scheme associated with YUV color formatted data. The method then advances to operation 152 where a size associated with the video display data is adjusted. Here, a scale factor and a crop factor may be applied to the data in order to adjust the size. That is, the size is adjusted for the eventual display panel to which the data may be output.

The method of FIG. 5 then proceeds to operation 154 where the video display data is compressed through a second sub-sampling scheme. Here, as described above, the 4:2:2 compression scheme sub-sampled to produce either a 4:2:1 compression scheme or a 4:2:0 compression scheme. It should be appreciated that the terms sub-sampled and down sampled may be used interchangeably herein. Thus, through the conversion block mentioned above with reference to FIGS. 3 and 4, the video display data is further compressed in order to store the video display data in memory in the most efficient manner. One skilled in the art will appreciate that hand-held electronic devices are generally limited in the amount of resources, i.e., computing power and memory, therefore, the compression achieved will further reduce the amount of space occupied in memory by the display data. Thus, memory space is freed up for other purposes through the embodiments described herein. The method then moves to operation 156 where the compressed data having the color format is stored. As described above, with reference to FIGS. 3 and 4, the stored data may be accessed and displayed directly by a YUV display device. Alternatively, the stored data may be accessed and converted to an RGB color format for eventual display on a liquid crystal display (LCD) device. Of course, the data may also be accessed and converted eventually to a JPEG file or some other suitable lossy compression scheme for eventually display. Additionally, it should be appreciated that the compressed video display data may be converted to a second color format, e.g., RGB color format, and then stored within memory 114. However, a memory savings associated with the storage of the compressed YUV formatted data would not be achieved here.

In summary, the above-described embodiments allow for the efficient use of memory by utilizing the compression of incoming YUV color data. That is, YUV data having a 4:2:2 format is associated with a bit size of 16 bits per pixel while RGB data is associated with a bit size of 24 bits per pixel. Therefore, it is optimal to store YUV data in a 4:2:2 compression scheme or some other lower compression scheme in memory. The display controller described herein is a LCD controller in one embodiment. However, the display controller is not limited to a LCD controller as the display controller may be any suitable display controller.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data which can be thereafter read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

The above described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

1. A method for enhancing storage capability for a display controller, comprising:
receiving video display data having a color format associated with a first sub-sampling scheme;
adjusting a size associated with the video display data;
compressing the video display data through a second sub-sampling scheme; and
storing the compressed data having the color format.

2. The method of claim 1, wherein the method operation of adjusting a size associated with the video display data includes,
adjusting one of a cropping factor and a scaling factor associated with the video display data.

3. The method of claim 1, further comprising:
converting the compressed data to a different color format; and
storing the different color format.

4. The method of claim 1, further comprising:
accessing the stored compressed data; and
converting a frame of the stored compressed data through a lossy compression scheme.

5. The method of claim 1, wherein the color format is selected from the group consisting of YUV color format, YCbCr color format and YIQ color format.

6. The method of claim 1, wherein the color format is a YUV color format.

7. The method of claim 6, wherein the first sub-sampling scheme is a 4:2:2 sub-sampling scheme and the second sub-sampling scheme is one of a 4:1:1 sub-sampling scheme and a 4:2:0 sub-sampling scheme.

8. The method of claim 4, wherein the lossy compression scheme is a Joint Photographic Expert Group (JPEG) compression scheme.

9. A computer readable medium having program instructions for enhancing storage capability for a display controller, comprising:
program instructions for receiving video display data having a color format associated with a first sub-sampling scheme;
program instructions for adjusting a size associated with the video display data;
program instructions for compressing the video display data through a second sub-sampling scheme; and
program instructions for storing the compressed data having the color format.

10. The computer readable medium of claim 9, wherein the program instructions for adjusting a size associated with the video display data includes,
program instructions for adjusting one of a cropping factor and a scaling factor associated with the video display data.

11. The computer readable medium of claim 9, further comprising:
program instructions for converting the compressed data to a different color format; and
program instructions for storing the different color format.

12. The computer readable medium of claim 9, further comprising:
program instructions for accessing the stored compressed data; and
program instructions for converting a frame of the stored compressed data through a lossy compression scheme.

13. A display controller, comprising:
a resizer block configured to receive digital video data defined through a YUV color format, the resizer block capable of scaling and cropping the digital video data;
a conversion module configured to compress the digital video data defined through the YUV color format;
a memory region configured to store the compressed digital video data; and
a color space conversion block configured to convert the compressed digital video data from the YUV color format to an RGB color format for display.

14. The display controller of claim 13, further comprising:
a Joint Photographic Expert Group (JPEG) block in communication with the resizer block, the JPEG block configured to encode one of the digital video data and the compressed digital video data.

15. The display controller of claim 13, wherein the digital video data is received in a 4:2:2 YUV format and the compressed digital video data is one of a 4:1:1 YUV format and a 4:2:0 YUV format.

16. The display controller of claim 13, wherein the conversion module sub-samples the digital video data in order to compress the digital video data.

17. The display controller of claim 13, wherein the color space conversion block is further configured to independently apply a scale factor and an offset factor prior to applying a transform matrix to the compressed digital video data.

18. The display controller of claim 13, wherein the color space conversion block is further configured to manipulate a color balance associated with the RGB color format through manipulation of an offset factor applied after the application of a transform matrix to the compressed digital video data.

19. A digital video device, comprising:
a central processing unit (CPU);
a display controller, the display controller including,
a resizer block configured to receive digital video data defined through a YUV color format, the resizer block capable of scaling and cropping the digital video data;
a conversion module configured to compress the digital video data defined through the YUV color format; and
a memory region configured to store the compressed digital video data;
a display panel configured to display the stored digital video data; and
a bus over which the CPU, the display controller and the display panel communicate.

20. The device of claim 19, wherein the device is a digital video device selected from the group consisting of a cellular phone, a camcorder, and a personal digital assistant (PDA).

21. The device of claim 19, wherein the display controller includes,
a color space conversion block configured to convert the compressed digital video data from the YUV color format to an RGB color format for display.

22. The device of claim 21, wherein the display controller is a liquid crystal display (LCD) controller and the display panel is a LCD panel.

23. The device of claim 19, wherein the digital video data is received from one of a digital camera, a digital video decoder, and a Motion Picture Expert Group (MPEG) decoder.

24. An integrated circuit, comprising:
circuitry for receiving previously compressed digital video data;
circuitry for sub-sampling the previously compressed digital video data; and
circuitry for storing the sub-sampled data.

25. The integrated circuit of claim 24, further comprising:
circuitry for scaling and cropping a size associated with the digital video data.

26. The integrated circuit of claim 24, wherein the digital video data is YUV data associated with a 4:2:2 compression scheme and the sub-sampled data is associated with one of a 4:1:1 compression scheme and a 4:2:0 compression scheme.

27. The integrated circuit of claim 24, further comprising:
circuitry for converting the sub-sampled data to a RGB color format.

28. The integrated circuit of claim 24, wherein the integrated circuit is included within a display controller.
